(19) United States
(12) Patent Application Publication
(10) Pub. No.: US 2026/0095063 A1
(43) Pub. Date: Apr. 2, 2026

(54) PLANT CONTROLS FOR SELF-SUPPLY APPLICATIONS OF ENERGY STORAGE SYSTEMS

(71) Applicant: Fluence Energy, LLC, Arlington, VA (US)

(72) Inventors: Benjamin Joseph Braun, Berlin (DE); Ngoc Bao Lai, Fürth (DE); Thorben Zieseniss, Erlangen (DE); Ioannis Arvanitis, Berlin (DE)

(73) Assignee: Fluence Energy, LLC, Arlington, VA (US)

(21) Appl. No.: 19/345,627

(22) Filed: Sep. 30, 2025

Related U.S. Application Data
(60) Provisional application No. 63/701,520, filed on Sep. 30, 2024.

(51) Int. Cl. H02J 9/06; H01M 10/42; H01M 10/48; H01M 50/204; H01M 50/258; H01M 50/507; H02J 7/00

(52) U.S. Cl. CPC H02J 9/062; H01M 10/425; H01M 10/482; H01M 50/204; H01M 50/258; H01M 50/507; H02J 7/585; H02J 7/82; H01M 2220/10

(57) ABSTRACT

An energy storage system having a self-supply mode includes a plurality of battery energy storage system (BESS) modules, a plant controller, and an auxiliary system. The plant controller operates the energy storge system in a self-supply mode to supply electric power to the auxiliary system when the energy storage system is disconnected from an electric grid. The self-supply mode includes monitoring, for each of the rechargeable BESS enclosures, a state of charge parameter (SoC), sequentially activating one of the rechargeable BESS enclosures to supply electric power to the auxiliary system, and upon determining that the SoC of the one of the rechargeable BESS enclosures is less than a threshold, deactivating the one rechargeable BESS enclosure and activating another of the plurality of rechargeable BESS enclosures to supply electric power to the auxiliary system.

### CROSS REFERENCE TO RELATED APPLICATION

This application claims the benefit of, and right of priority to, U.S. Provisional Patent Application No. 63/701,520, filed Sep. 30, 2024, and entitled “PLANT CONTROLS FOR SELF-SUPPLY APPLICATIONS OF DC ENERGY STORAGE SYSTEMS,” the contents of which are expressly incorporated by reference as if fully set herein.

### INTRODUCTION

The concepts described herein relate generally to energy storage systems, and more specifically, to modular energy storage systems that supply electric power to an electric grid.

A modular energy storage system includes multiple energy storage system modules that are selectively interconnected to provide varied levels of storage capacity for electrical energy generated from one or more sources, and supply electrical energy to public and/or private consumer(s) via electric grid(s). The modular energy storage system may be used to store additional power produced by an external power source during periods of reduced demand, and provide additional power to external power sources during periods of increased demand.

Each modular energy storage system includes an array of multiple energy storage system modules that are connected via one or multiple bus bars. Each energy storage system module includes one or multiple rechargeable electrical energy storage enclosures, a power converter, a transformer, a battery energy storage system (BESS) circuit breaker, and a controller.

A BESS is one form of a modular electric energy storage system having multiple battery energy storage system modules that are interconnected.

In the event of a grid outage, a control system for a BESS needs to maintain communication and control of the BESS, including the auxiliary power circuit, to reconnect to the electric grid after it is restored, without manual intervention.

### SUMMARY

There is a need for a battery energy storage system (BESS) having an auxiliary power circuit that is capable of self-supply of electric power during a grid outage.

The concepts described herein relate to a plant controller for direct current (DC) battery energy storage systems (BESS) that provides self-supply and black start capability. Unlike conventional project specific black start solutions, the disclosed control architecture introduces a standardized interface between a remote terminal unit (RTU) and a generic BESS (system) controller, enabling seamless integration of site-specific breaker configurations, busbar topologies, and operational data into a common software framework. The plant controller supports multiple operational modes including self-supply, black start, and hybrid operation, with automated state-of-charge (SoC) balancing through core-swapping algorithms to ensure extended auxiliary power supply during outages. The approach allows scalable, and reliable deployment of BESS black start applications across different grid configurations (single busbar, bus coupler, and double busbar), validated through controller-hardware-in-the-loop testing.

The concepts described herein further provide a plant controller and associated method for a BESS that is capable of operating in a self-supply mode, including providing for an auxiliary power circuit, during an electric grid outage. The BESS is sized to be able to supply electrical power to an electric grid, e.g., a public grid, a local industrial grid, a personal grid, etc., when connected via a main circuit breaker.

An aspect of the disclosure may include the BESS having a plurality of BESS modules, first and second bus bars, a bus coupler, a plurality of BESS circuit breakers, an operating system that is embodied as a plant controller, and one or a plurality of auxiliary systems. Each of the BESS modules includes one or a plurality of rechargeable BESS enclosures, a power converter, one or a plurality of sensors, and a plurality of internal circuit breakers. Each of the plurality of BESS modules is connectable to an electric grid via a respective one of the plurality of BESS circuit breakers and one of the first and second bus bars. The plant controller is in communication with and/or operatively connected to the plurality of BESS modules, the bus coupler, the sensor, and the plurality of BESS circuit breakers. The plant controller is configured to operate the BESS in a self-supply mode to supply electric power to the auxiliary system when the BESS is disconnected from the electric grid. The self-supply mode includes: monitoring, for each of the plurality of rechargeable BESS enclosures, a state of charge parameter (SoC); sequentially activating one of the plurality of rechargeable BESS enclosures to supply electric power to the auxiliary system; and upon determining that the SoC of the one of the plurality of rechargeable BESS enclosures is less than a threshold, deactivating the one of the plurality of rechargeable BESS enclosures and activating another of the plurality of rechargeable BESS enclosures to supply electric power to the auxiliary system.

Another aspect of the disclosure may include the plant controller being configured to detect an outage of the electric grid, and disconnect the plurality of BESS modules from the electric grid in response thereto.

Another aspect of the disclosure may include the plant controller being configured to open the plurality of BESS circuit breakers to disconnect the plurality of BESS modules from the electric grid upon detecting the outage of the electric grid.

Another aspect of the disclosure may include the plant controller being configured to disconnect the power converter of the respective one of the plurality of rechargeable BESS enclosures being deactivated.

Another aspect of the disclosure may include deactivating the one of the plurality of rechargeable BESS enclosures subsequent to activating the another of the plurality of rechargeable BESS enclosures to supply electric power to the auxiliary system.

Another aspect of the disclosure may include the plurality of BESS modules further including a thermal management system configured to manage thermal energy of the plurality of BESS modules. The plant controller is operatively connected to the thermal management system, and is configured to minimize operation of the thermal management system to manage thermal energy of the plurality of BESS modules upon detecting the outage of the electric grid. Minimizing operation of the thermal management system means minimizing electric power consumed by the thermal management system upon detecting the outage of the electric grid.

Minimizing operation of the thermal management system to manage thermal energy of the plurality of BESS modules includes operating only a portion of the thermal management system, i.e., that portion of the thermal management system that is thermally coupled to the one of the plurality of rechargeable BESS enclosures that is activated to supply electric power to the auxiliary system upon detecting the outage of the electric grid.

Another aspect of the disclosure may include each of the plurality of BESS modules being an energy storage module that is composed of a plurality of electrochemical batteries, a power converter, and a transformer.

Another aspect of the disclosure may include the plant controller being operative to control a plurality of setpoints for each of the plurality of BESS modules.

The setpoints may include active power (P), reactive power (Q), voltage (V), and/or frequency (f).

Another aspect of the disclosure may include the plant controller being operative to control a plurality of setpoints for each of the plurality of BESS modules. The setpoints may include operation modes of being connected, disconnected, grid-forming (GFM) operation, and grid-following (GFL) operation. The power converters (or inverters) need to be capable of grid-forming (GFM) operation to energize bus bars and transformers, and do not require an existing grid voltage to synchronize on. Additionally, the power converters must be able to pre-charge from the DC-side as there is no AC voltage available when the first power converter starts up after a power outage.

Another aspect of the disclosure may include the plant controller being able to monitor present states of the plurality of BESS modules, including a state of charge (SoC), state of health (SoH), power, voltage, temperature, cell balancing, etc.

Control and communication systems are advantageously equipped with an uninterruptible power supply (UPS), so that the control system remains operational during a grid outage. Since UPS capacities are limited and the power plant may be required to stay online for several days before a black-start mode is commanded in the BESS, or grid restoration from another source occurs, the BESS needs to transition into a self-supply mode when an outage is detected. In self-supply mode, the BESS itself provides auxiliary electric power for operating the power plant during the grid outage, until a black-start command is received from the plant controller or system operator, or until the grid is restored from another source.

The concepts described herein allow for operation in a black-start mode, with resynchronization to an operational grid occurring in a grid-forming operation, or in a grid-following operation.

The self-supply mode includes providing a stable voltage to the auxiliary transformer with only a portion, e.g., a minimum section of the power plant in operation. Therefore, the plant controller for the BESS will have to swap the connected batteries over time to maintain SOC balance within the power plant.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the claims.

### BRIEF DESCRIPTION OF THE DRAWINGS

One or more embodiments will now be described, by way of example, with reference to the accompanying drawings, in which:

FIG. 1 schematically illustrates an embodiment of a power plant including a battery energy storage system (BESS) module having a plurality of BESS enclosures in operative in communication with and operably connected to an energy system, e.g., an electric grid, in accordance with the disclosure.

FIG. 2 schematically illustrates an embodiment of an energy storage system including a plurality of rechargeable BESS modules, in accordance with the disclosure.

FIG. 3 schematically illustrates details related to an embodiment of a plant controller for a power plant including an energy storage system, in accordance with the disclosure.

FIG. 4 graphically illustrates operating parameters (States of Charge or SoC) for a plurality of BESS enclosures over time during operation of a power plant in a self-supply mode, in accordance with the disclosure.

The appended drawings are not necessarily to scale, and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description to provide a thorough understanding of the embodiments disclosed herein, some embodiments may be practiced without some of these details. Moreover, for the purpose of clarity, certain technical material that is understood in the related art has not been described in detail to avoid unnecessarily obscuring the disclosure.

Furthermore, the drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure. Furthermore, the disclosure, as illustrated and described herein, may be practiced in the absence of an element that is not specifically disclosed herein.

The following detailed description is merely exemplary in nature and is not intended to limit the application and uses. Furthermore, there is no intention to be bound by any expressed or implied theory presented herein. Throughout the drawings, corresponding reference numerals indicate like or corresponding parts and features.

As used herein, the term “system” may refer to one of or a combination of mechanical and electrical actuators, sensors, controllers, application-specific integrated circuits (ASIC), combinatorial logic circuits, software, firmware, and/or other components that are configured to provide the described functionality.

The use of ordinals such as first, second and third does not necessarily imply a ranked sense of order, but rather may only distinguish between multiple instances of an act or structure.

All numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range. Each value within a range and the endpoints of a range are hereby all disclosed as separate embodiments.

The term “controller” and related terms such as microcontroller, control, control unit, processor, etc. refer to one or various combinations of Application Specific Integrated Circuit(s) (ASIC), Field-Programmable Gate Array(s) (FPGA), electronic circuit(s), central processing unit(s), e.g., microprocessor(s) and associated non-transitory memory component(s) in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning, buffer circuitry and other components, which may be accessed by and executed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Each controller executes control routine(s) to provide desired functions. Routines may be executed at regular intervals, for example every 100 microseconds during ongoing operation. Alternatively, routines may be executed in response to occurrence of a triggering event. Communication between controllers, actuators and/or sensors may be accomplished using a direct wired point-to-point link, a networked communication link, a wireless link, or another communication link. Communication includes exchanging data signals, including, for example, electrical signals via a conductive medium; electromagnetic signals via air; optical signals via optical waveguides; etc. The data signals may include discrete, analog and/or digitized analog signals representing inputs from sensors, actuator commands, and communication between controllers.

The term “signal” refers to a physically discernible indicator that conveys information, and may be a suitable waveform (e.g., electrical, optical, magnetic, mechanical or electromagnetic), such as DC, AC, sinusoidal-wave, triangular-wave, square-wave, vibration, and the like, that is capable of traveling through a medium.

The terms “calibration”, “calibrated”, and related terms refer to a result or a process that correlates a desired parameter and one or multiple perceived or observed parameters for a device or a system. A calibration as described herein may be reduced to a storable parametric table, a plurality of executable equations or another suitable form that may be employed as part of a measurement or control routine.

A parameter is defined as a measurable quantity that represents a physical property of a device or other element that is discernible using one or more sensors and/or a physical model. A parameter may have a discrete value, e.g., either “1” or “0”, or may be infinitely variable in value.

Throughout the drawings, various embodiments of an energy system or that includes a power plant having one or multiple battery energy storage system (BESS) modules, a BESS plant controller, and a substation controller, in communication with and operably connected to an electric grid to generate, transmit, convert, distribute, store, and/or use energy from an external energy source, i.e., energy producers to an electrical grid, i.e., energy consumers and/or an auxiliary power system are described.

An energy system may include, for example, any system configured to generate, transmit, convert, distribute, store, and/or use energy (e.g., electrical energy) and/or associated with any other aspect of energy. As one example, an energy system may include an electric grid. An electric grid may include, for example, an interconnected network for electricity delivery from producers to consumers. An electric grid may include, for example, power stations (e.g., thermal power stations, photovoltaic power stations, solar farms, wind power stations, wind farms, hydroelectric power stations, etc.), substations (e.g., for transforming voltage from higher to lower voltage levels, or from lower to higher voltage levels, or for performing other functions associated with transmitting electrical energy between producers and consumers), electrical power transmission and/or distribution (e.g., transmitting electrical energy from producers to substations, and/or delivering electrical energy from a transmission system to consumers), and/or other elements.

In one example, an electric grid may include, for example, an interconnected network for electricity delivery from energy producers to energy consumers. Energy producers may include external power sources, for example, power stations (e.g., thermal power stations, photovoltaic power stations, solar farms, wind power stations, wind farms, hydroelectric power stations, etc.), substations (e.g., for transforming voltage from higher to lower voltage levels, or from lower to higher voltage levels, or for performing other functions associated with transmitting electrical energy between producers and consumers), electrical power transmission and/or distribution (e.g., transmitting electrical energy from producers to substations, and/or delivering electrical energy from a transmission system to energy consumers), and/or other elements.

In some examples, the power converter may include DC to AC conversion, e.g., using a power inverter, and/or may include AC to DC conversion, e.g., using a rectifier. As one example, the batteries may output electrical energy in the form of direct current, which the power converter may convert into alternating current, e.g., for supplying to a power line or electric grid operating with alternating current.

As another example, the power converter may convert alternating current, e.g., received from a power line or electric grid operating with alternating current into direct current for inputting to or charging the batteries. Additionally, or alternatively, the power converter may include AC to AC conversion (via a transformer) and/or may include DC to DC conversion (via a rectifier). The power converter may be configured to convert electrical energy from the batteries into any form for outputting, e.g., to an auxiliary system or load, and/or may be configured to convert electrical energy from another source into a suitable form for inputting to or charging of the batteries. For example, the power converter may be used for coupling the batteries to a power bus or an electric grid.

In some examples, the power converter may include a structure or component that may be applicable to the batteries collectively. In some examples, the power converter may include multiple structures or components each of which may be respectively applicable to a corresponding battery of the BESS. In some examples, the power converter may include a structure or component that may be applicable to some of the batteries collectively, and the power converter may include multiple structures or components each of which may be respectively applicable to a corresponding battery of other batteries of the BESS.

In some examples, a power conversion system may be used for multiple BESS modules collectively (e.g., for converting electrical energy from the multiple energy BESS modules into a desired form for outputting to a load, or for converting electrical energy from a source into a desired form for inputting to or charging the multiple BESS modules).

The thermal management system may include any type of device configured to remove and/or add heat to the BESS module and the power converter. The thermal management system may use air, liquid, solid material, gaseous material, and/or any other type of suitable medium or material to remove heat employing conductive heat transfer, convective heat transfer, radiant heat transfer, or another form of heat transfer.

In some examples, the thermal management system may include heat sinks and/or thermal management fins. In some examples, the thermal management system may include fans (e.g., for moving air in air-cooling), pumps (e.g., for moving a liquid in liquid-cooling), compressors (e.g., for vapor-compression refrigeration), or any other type of device for thermal management. The thermal management system may have any desired configuration (e.g., shape, size, weight, functionality, etc.), and/or may be disposed, placed, oriented, or distributed in association with sensor(s), and the power converter. In some examples, the computing device may control the components based on instructions from another computing device (e.g., the energy storage controller device). Additionally, or alternatively, data associated with the BESS module may be recorded or stored, including, for example, data measured by the sensor(s), data used by the BESS module (e.g., parameters for controlling the batteries, parameters for controlling the power converter, or parameters for controlling the thermal management system), or any other type of data. The recorded or stored data may be used or processed by the computing device and/or another computing device (e.g., the energy storage controller device) in connection with one or more aspects described herein.

The sensors may be any type of sensor capable of measuring or assessing one or more parameters of the BESS module. The sensors may include, for example, voltage sensors, current sensors, frequency sensors (e.g., power bus frequency sensors), power sensors (e.g., for measuring the active power or reactive power of an electric grid), or other types of sensors for obtaining measurements associated with the system 100. The sensors may have any desired configuration (e.g., shape, size, weight, functionality, etc.). The sensors may be configured to obtain measurements of an electric grid, including the power bus. For example, the sensor may be configured to measure the frequency of alternating current as transmitted via the power bus (e.g., the voltage at the bus bar associated with or included in the power bus), or the sensor may be configured to measure the frequency of alternating current as transmitted via the power bus, e.g., the voltage at the bus bar associated with or included in the power bus. The sensors may be coupled to the electric grid in any desired manner, e.g., by electrically coupling to the points of connection of the electric grid. The sensors may send measured data to the energy storage controller device. It is contemplated that the system may employ one or multiple sensors.

Power for operating the thermal management system is supplied via the auxiliary system during a grid outage.

The plant controller is configured to communicate with and control operation of each of the BESS modules employing the remote terminal unit and the control system. The plant controller includes a collection of control processes that are used to monitor and control various elements of the power plant. A Market Dispatch Unit (MDU) is responsible for generating active and reactive power dispatch set-points to fulfill the requirements of one or multiple market applications.

The various elements of the power plant are configured to communicate with each other via a network, including employing interconnected wired and/or wireless communication links.

The control and communication systems are equipped with an uninterruptible power supply (UPS), so that the control system has sufficient power to remain operational during and after a grid outage. Since UPS capacities are limited and the power plant may be required to stay online for several days during a grid outage, the plant controller transitions the power plant into a self-supply mode when a grid outage is detected. In this mode, the BESS modules provide the auxiliary power for the power plant, including the UPS, during the grid outage. The self-supply mode provides a stable voltage to the auxiliary transformer with only a portion, e.g., a minimum section of the power plant, in operation.

In addition, the BESS module may refer to any system configured to store energy that is convertible to electric power. The power plant may include the BESS modules being arranged as a centralized system or as a distributed system. The power plant may include one or more BESS modules. In some examples, the BESS modules may be located in a single physical location, such as a site. It is contemplated that the power plant may include one or multiple BESS modules, each having one or multiple nodes or rechargeable BESS enclosures.

While these characteristics are sufficient for most of the projects and applications to date, the self-supply and black-start requirements add another level of complexity to the plant controller. For example, site related information such as single or double bus bar configurations, breaker states, etc. are available in the remote terminal but they are also required within the control system to connect or disconnect the appropriate BESS modules.

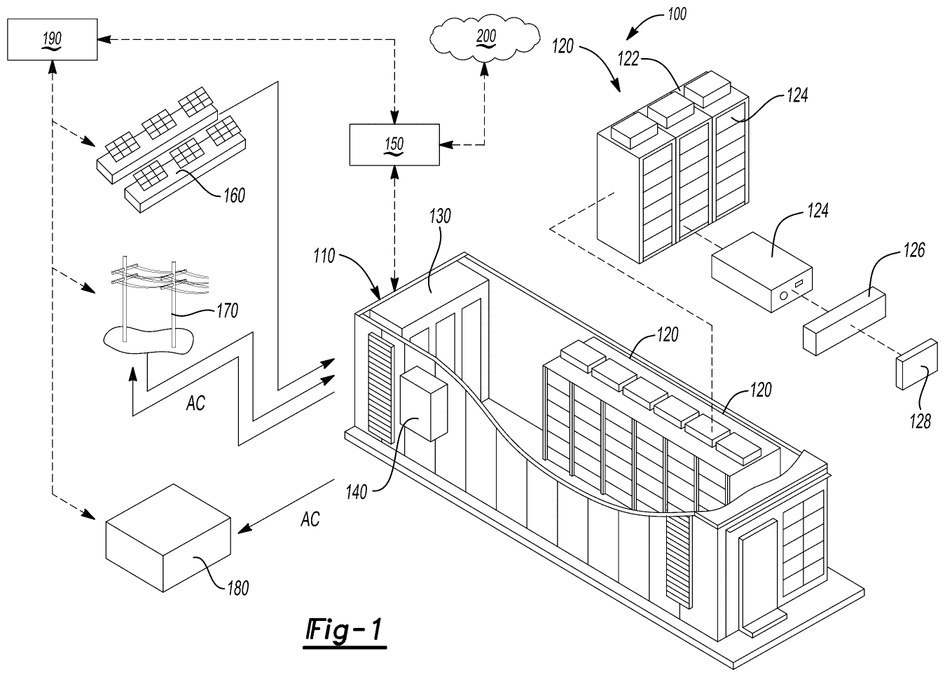

Referring to the drawings, wherein like reference numbers refer to the same or like components in the several Figures, FIG. 1 schematically illustrates a power plant 100 including a BESS module 110 having a plurality of nodes or BESS enclosures 120, a power conversion system 130, and a thermal management system 140.

A BESS controller 150, in communication with the BESS module 110, is configured to monitor and control the various components included in the BESS module 110.

Each of the plurality of BESS enclosures 120 includes a battery rack 122 having a plurality of battery packs 124. Each of the plurality of battery packs 124 includes a plurality of battery modules 126 having a plurality of batteries 128 arranged within each of the plurality of battery modules 126.

The plurality of BESS enclosures 130 are coupled to one another electrically, and collectively coupled to a power conversion system 130. The plurality of BESS enclosures 130, individually and collectively, are operable to store alternating current (AC) power delivered from an external power source 160 as direct current (DC) power, for example but not limited to when the demand for power from the external power source 160 is lower than the external power source 160 is operable to generate, and/or to provide DC power for an electrical application 170, which may include an electrical grid, for example but not limited to when the demand for power is higher than the external power source 160 is operable to generate. It should be appreciated that the plurality of BESS storage enclosures 120 may be coupled to one another not only electrically, but also mechanically, and/or fluidly.

To facilitate the conversion of AC power to DC power and DC power to AC power, the power conversion system 130 is configured to standardize power input and output between the plurality of BESS enclosures 120 and the external power source 160. The power conversion system 130 may include, for example but not limited to, one or multiple power converters (or inverters) configured to convert AC power to DC power, and/or DC power to AC power.

According to one aspect of the disclosure, the BESS module 110 is configured to provide power to an auxiliary power system 180, which may include but is not limited to battery and power converter thermal management, control systems, communications etc.

A substation controller 190 communicates with the BESS controller 150 to operate and monitor the BESS plant 100 including but not limited to receiving commands from a customer and converting the commands into BESS controls and site-specific commands.

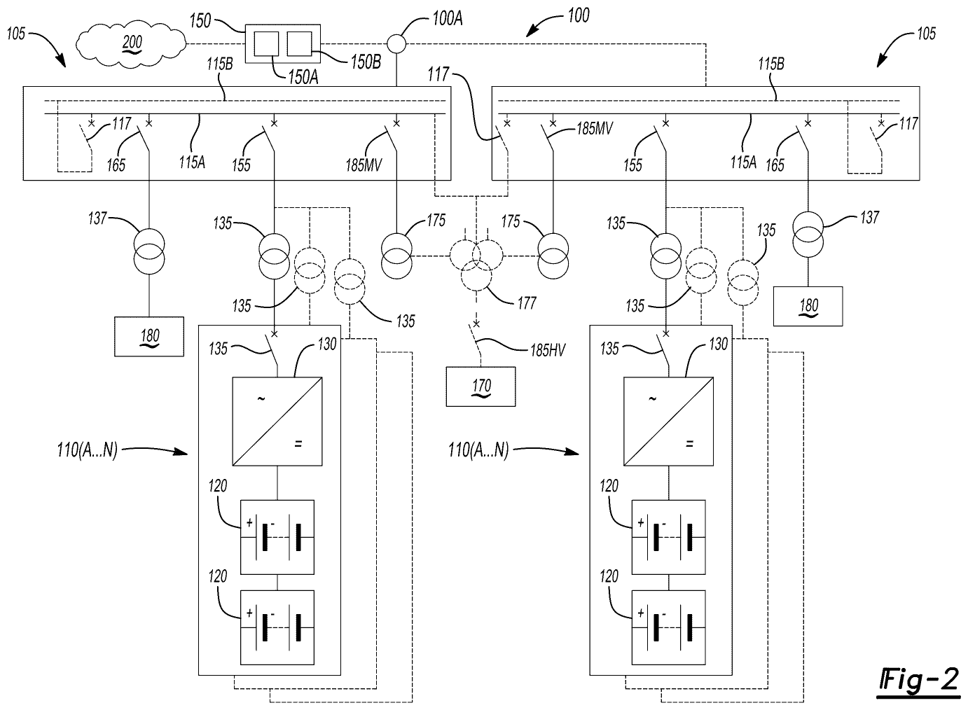

As schematically illustrated in FIG. 2 with continued reference to FIG. 1, an embodiment of a topology for a power plant 100 for supplying electric power to an electric grid 170 includes multiple battery energy storage systems (BESSs) 110 (A . . . N), a plant controller 150, and a substation controller 190.

The power plant 100 is advantageously arranged in a plurality of arrays 105 with each of the plurality of arrays 105 having a plurality of BESSs 110 (A . . . N) including BESS enclosures 120, a first bus bar 115A, a second bus bar 115B, BESS enclosure circuit breakers 135, BESS circuit breakers 155, and BESS transformers 135.

The first and second bus bars 115A, 115B are redundant, thus enabling electric power flow to the BESSs 110 (A . . . N) in accordance with the selected operating mode.

Bus couplers 117 are arranged between the first bus bar 115A and the second bus bar 115 to operably connect the first bus 115A to the second bus bar 115B, and between the respective first bus bars 115A of each array 105.

Medium voltage (MV) main circuit breakers 185MV are arranged between the second bus bar 115B and transformers 175, a three-phase transformer 177 is arranged between the transformers 175, and a high voltage (HV) main circuit breaker is arranged between the three-phase transformer 177 and an electric grid to operably connect arrays 105 to the electric grid 170.

Each BESS module 110 (A . . . N) has one or multiple nodes, and each node represents a rechargeable BESS enclosure 120. Alternatively, a single bus bar may be implemented and employed for enabling electric power flow to the BESS modules 110 (A . . . N) in accordance with the selected operating mode.

Each array 105 of BESS modules 110 (A . . . N) is controllable by the BESS plant controller 150 to selectively connect the respective BESS 100 to the first bus bar 115A via respective BESS circuit breakers 155.

Each BESS module 110 (A . . . N) advantageously includes one of or a plurality of rechargeable BESS enclosures 120, a power converter (or inverter) 130, internal disconnect circuit breakers 135, one or multiple sensors (not shown), and a thermal management system 140, in one embodiment.

Each BESS 100 is selectively connectable to an electric grid 170 and/or an auxiliary system 180 of the power plant 100 by action of the plant controller 150.

The array 105 is one form of a modular energy storage system having multiple BESS modules 110 (A . . . N) that are interconnected.

Each BESS module 110 (A . . . N) is selectively electrically connectable to the first bus bar 115A and respective BESS circuit breaker 155 to supply electric power to the electric grid 170 via the respective BESS circuit breaker 155, by action of the plant controller 150, as detailed with reference to the embodiments illustrated herein.

Each BESS module 110 (A . . . N) is couplable to an external power source 160, the electric grid 170, or an auxiliary power supply 180 to effect charging. The external power source 160 may originate from solar, wind, geothermal, nuclear, natural gas, coal, diesel fuel, methane, biofuel, or another energy source.

The BESS modules 110 (A . . . N) include one of or a plurality of BESS enclosures 120, which are DC energy storage devices (or batteries) that include one or more rechargeable electrochemical cells. The rechargeable electrochemical cells may include one or more of various types of batteries, such as lithium-ion batteries, lithium iron phosphate batteries, silver-oxide batteries, nickel-zinc batteries, nickel metal hydride batteries, lead-acid batteries, nickel-cadmium batteries, lithium nickel manganese cobalt oxides (NMC) batteries, lithium nickel cobalt aluminum oxides (NCA) batteries, lithium ion manganese oxide (LMO) batteries, lithium cobalt oxide batteries, fuel cells, or other types of batteries. Alternatively, or in addition, the DC energy storage devices may be in the form of ultracapacitors, flywheels, fuel cells, etc., without limitation.

Each BESS enclosure 120 may have control components associated therewith. The control components may be, for example, configured to individually manage the charge and discharge of each of the batteries. The control components may include, for example, battery management systems (BMS). In some examples, each of the batteries may have a dedicated on-board control component (e.g., a battery management system). The control component for each of the batteries may be implemented by a computing device, and/or may communicate with a central management controller. Additionally, or alternatively, the central management component may manage the charge and discharge of the batteries collectively. The charge and discharge of the batteries of the BESS modules may be controlled using devices and control algorithms, such as circuits with circuit breaker controls, charge or discharge controllers, charge or discharge regulators, battery regulators, and/or the like, so that each of the batteries may be controlled to be in a state of receiving electricity from a source at a particular rate, in a state of outputting electricity to a load at a particular rate, or in a state of being idle or disconnected.

Each of the BESS modules 110 (A . . . N) includes a power converter (or inverter) 130. The power converter 130 may refer to, for example, any system that is operable to convert electric power from one form to another form. For example, the power converter 130 may be configured to convert alternating current (AC) to direct current (DC), convert direct current to alternating current, convert an alternating current at a first frequency and/or magnitude to another alternating current at a second frequency and/or magnitude, convert direct current at a first magnitude to direct current at a second magnitude, etc.

The plant controller 150 for the power plant 100 is composed of a remote terminal unit 150A and a BESS controller 150B. The remote terminal unit 150A is the interface to the customer and an external Supervisory Control and Data Acquisition (SCAA) system 200. The external SCADA system 200 is a computer-based system that monitors and controls industrial processes and equipment. The external SCADA system 200 uses a combination of hardware and software to collect data from devices and equipment, and then apply operational controls over long distances. The external SCADA system 200 may be used to monitor processes, maintain and improve efficiencies, improve quality and profitability, reduce waste, and identify problems and emergencies. Internally, it communicates with the BESS controller 150B and the substation controller 190 by which it operates and monitors the circuit breakers of the power plant 100.

The external SCADA system 200 receives operating commands from the customer and converts them into plant controller-specific and site-specific commands (e.g. start/stop commands, operation modes, breaker operations...). Additionally, it collects operating values of the power plant 100 from the BESS controller 150B and the substation controller 190 and reports them to the customer and the external SCADA system 200. While the remote terminal 150A is very project specific by nature, the BESS controller 150B may handle a variety of applications (e.g. frequency control in different markets) and configurations such as different project sizes, power converters and batteries.

The BESS controller 150B processes the commands from the remote terminal 150A, determines the action for each power converter and battery and controls the power plant's operation at the point of interconnection (POI) 100A.

The plant controller 150, in communication with the substation controller 190 is configured to monitor and control different elements of the plurality of BESS modules (A . . . N) 110, including the respective BESS circuit breakers 155 and the BESS enclosures 120. This includes selectively electrically connecting the plurality of BESS modules 110 (A . . . N) to the electric grid 170 via the respective BESS circuit breaker 115 and the first and second bus bars 115A, 115B to transfer electric power, which may be related to a charging mode or a discharging mode.

The BESS controller 150B may be organized in different control layers. One layer manages all actions on a plant level, and another layer deals with the control of individual BESSs, including the control of individual rechargeable BESS enclosures within the each BESS module 110 (A . . . N). Typical signals that are being sent to the BESS modules 110 (A . . . N) are setpoints, which may include active power (P), reactive power (Q), voltage (V), and/or frequency (f), and BESS operating modes. The BESS operating modes may include, e.g., Disconnected, grid-forming (GFM) operation, and/or grid-following (GFL) operation. Similarly, each BESS module 110 (A . . . N) reports back to the respective control layer current state information, e.g. State of Charge (SoC), power measurements etc.

The remote terminal 150A may interact with the BESS controller 150B. While the latter is employed to report power plant configurations and connection states of the BESS modules 110 (A . . . N), the main control interface between the remote terminal 150A and each array 105 is the plant operating mode, e.g., GFL, GFM, Self-Start (SS), and Black-Start (BS).

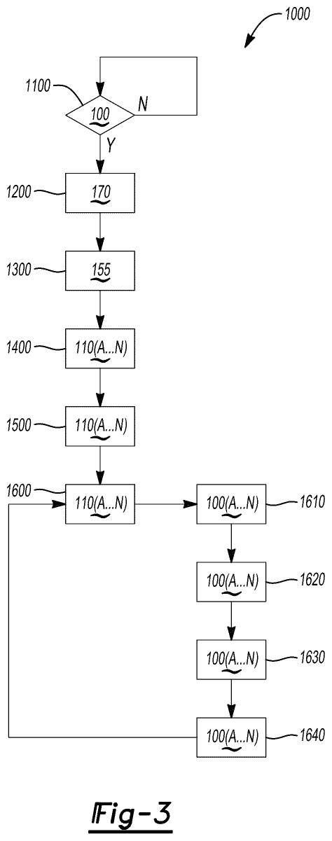

FIG. 3 schematically illustrates a method to operate at 1000 in a self-supply mode that may be executed by a plant controller 150 to operate at 1200 a power plant 100 in a self-supply mode by managing states of charge (SoC) of the plurality of BESS modules 110 when a power outage is detected at 1100.

The plant controller 150 is configured to operate at 1200 the power plant 100 in the self-supply mode to supply electric power to the auxiliary system 180 when the power plant 100 is disconnected at 1400 from the electric grid 170.

The plant controller 150 is configured to detect at 1100 an outage of the electric grid 170, disconnect at 1400 the plurality of BESS modules 110 (A . . . N) of the power plant 100 from the electric grid 170 when an outage is detected at 1100 in response thereto by opening at 1300 the plurality of BESS circuit breakers 155, and connecting at 1500 the plurality of the rechargeable BESS modules 110 to the auxiliary system 180 to supply electric power thereto. This may include activating or closing respective BESS circuit breaker 155 for the activated BESS and the auxiliary circuit breaker 165 for the auxiliary system 180.

While the power plant 100 is operating 1200 in the self-supply mode, the plant controller 150 acts on the elements of the power plant 100 to balance 1500 the SoCs of the plurality of BESS modules 110.

During operation in the self-supply mode, balancing at 1600 the SoCs of the plurality of rechargeable BESS modules 110 includes monitoring at 1610, for each of the plurality of BESS modules 110 (A . . . N), a state of charge parameter (SoC) via the sensors, estimation, or another method.

When it is determined at 1620 that the SoC of the one of the rechargeable BESS modules 110 (A . . . N) is less than a threshold, the one of the rechargeable BESS modules 110 (A . . . N) is deactivated at 1630, and another of the plurality of rechargeable BESS modules 110 (A . . . N) is activated at 1640 to supply electric power to the auxiliary system 180 during operation in the self-supply mode.

The threshold is a selected SoC value for the rechargeable BESS module 110 (A . . . N), and may be greater than a minimum allowable SoC value for the rechargeable BESS module 110 (A . . . N) to permit balanced states of charge for the plurality of battery rechargeable BESS modules 110 (A . . . N) of the power plant 100 during operation in the self-supply mode.

Operation in the self-supply mode is an iterative, sequential process that provides a downwardly spiraling SoC for the plurality of battery rechargeable BESS enclosures 120. This includes sequentially activating at 1640 at one of rechargeable BESS modules 110 (A . . . N), connecting at 1500 it to the auxiliary system 180, and monitoring at 1610 the SoC thereof. When the SoC of the activated one of the rechargeable BESS enclosures 120 is less than a threshold SoC, the one of the rechargeable BESS modules 110 (A . . . N) is deactivated at 1630, and another of the plurality of rechargeable BESS modules 110 (A . . . N) is activated at 1640 to supply electric power to the auxiliary system 180. This operation happens sequentially until the SoCs of all of the plurality of BESS enclosures 120 of the BESS modules 110 (A . . . N) have been reduced to the threshold SoC. At this point, the threshold SoC is incrementally reduced to a second, lesser SoC threshold, e.g., by an amount such as 1% SoC, and the process repeats itself. This includes sequentially activating at 1640 one of BESS modules 110 (A . . . N), connecting at 1500 it to the auxiliary system 180, and monitoring at 1610 the SoC thereof until the respective SoC is less than the second, lesser SoC threshold. In this manner, the SoCs of the rechargeable BESS enclosures 120 remain balanced.

Furthermore, the plant controller 150 operates to minimize operation of the thermal management system 140 to manage thermal energy of the plurality of BESS modules 110 (A . . . N) upon detecting at 1100 the outage of the electric grid 170. This may include only operating the thermal management system 140 of the selected one of the plurality of BESS modules 110 (A . . . N) that is activated at 1640 and connected at 1500 to the auxiliary system 180, and deactivating, not operating or minimizing the operation of the thermal management systems 140 of the plurality of BESS modules 110 (A . . . N) that are not presently selected or activated and not connected to the auxiliary system 180.

The plant controller 150 may work in tandem to detect a grid outage and automatically reconfigure the power plant 100 via opening of medium voltage (MV) main circuit breakers to reduce no-load losses. The plant controller 150 may rank and select BESS modules/BESS enclosures 110 (A . . . N)/120 based on Power/Energy capability, to dispatch the minimum power needed to meet power needs of the auxiliary system 180.

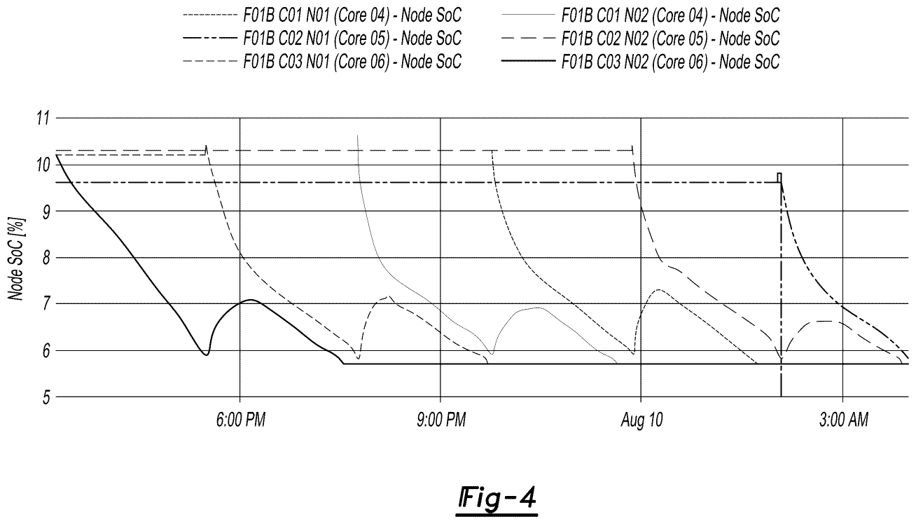

FIG. 4 graphically illustrates operating parameters (States of Charge or SoC) for a plurality of BESS enclosures 110 (A . . . N) over time during operation of an embodiment of the power plant 100 in a self-supply mode, wherein the power plant 100 is described with reference to FIG. 1 and FIG. 2, employing the control method described with reference to FIG. 3.

State of Charge (SoC) is depicted on the vertical axis, and time is depicted on the horizontal axis. The plotted lines illustrate SoC over time for individual BESS enclosures 120 (nodes N01, N02) of BESS modules 110 (04, 05, 06). The illustrated SoCs depict that a BESS module 110 (A...N) including a single one of the nodes, i.e., a single rechargeable BESS enclosure 120, is connected to the auxiliary system 180 by operation of the plant controller 150 during operation in the self-supply mode. The one of the rechargeable BESS modules 110 (A . . . N) is employed to power the auxiliary system 180 until its SoC reaches a threshold SoC, at which time another of the rechargeable BESS modules 110 (A . . . N) is connected to the auxiliary system 180 by operation of the plant controller 150 and the first of the rechargeable BESS modules 110 (A...N) is disconnected from the auxiliary system 180.

This operation happens sequentially, with individual rechargeable BESS modules 110 (A . . . N) being sequentially connected to the auxiliary system 180 by operation of the plant controller 150.

The threshold SoC is preferably greater than a minimum allowable SoC for the rechargeable BESS module 110 to permit balanced states of charge for the plurality of rechargeable BESS modules 110 (A . . . N) of the power plant 100 during operation in the self-supply mode.

This operation is also an iterative process that is a downwardly sequential SoC spiral, meaning that the threshold SoC is incrementally reduced, e.g., at 1% SOC each iteration, so that the SoCs of the rechargeable BESS modules 110 (A . . . N) remain balanced.

Operation in the Self-Supply mode ensures the power plant remains “awake” for extended periods with partial climatization, but could be more broadly implemented to non-GFM sites to minimize the power sizing traditional back-up power (UPS, diesel genset) by relaxing chiller setpoints and/or rotating chiller activation time on a BESS module/BESS enclosure 110/120 to BESS module/BESS enclosure 110/120 basis to maintain some climatization with minimal power. Power for the Self-Supply mode is less than 1% of nominal plant power. This allows the Self-Supply mode to operate even at minimal SOC levels in the power plant.

Commanded application modes may include an Offline mode, a Standby mode, a Grid Following mode, a Grid Forming mode that includes Droop, Isochronous, and Inertia modes, a Self-Supply mode, and a Black-start mode that may include self-supply.

In the Offline mode, power plant and its components will be brought into Disconnected Operation Mode.

In the Standby mode, the power plant and its components will be brought into Standby Operation Mode. The BESSs will need to be connected to the Main Grid.

In the Grid-Following mode, the power plant and its components will be brought into the Grid-Following Operation Mode with the option to perform steady-state secondary control. The BESSs will need to be connected to the Main Grid.

In the Grid-Forming modes, the voltage and frequency reference points are propagated from the Array module down to each BESS and BESS enclosure. In every application, though, the control strategy on the power plant level (Array) is different and in combination with the different electrical network configurations on each BESS, there is a need to introduce a new way of defining how the Array module needs to operate.

In the Grid-Forming Droop P/Q mode, the power plant and its components will be brought into the Grid-Forming Droop Operation Mode and the steady-state secondary control on the power plant level (Array) will be set to active and reactive power control. The BESSs will need to be connected to the Main Grid.

In the Grid-Forming Droop mode, the power plant and its components will be brought into the Grid-Forming Droop Operation Mode and the steady-state secondary control on the power plant level will be disabled. The BESSs will need to be connected to the Main Grid.

In the Grid-Forming Isochronous mode, the power plant and its components will be brought into the Grid-Forming Droop Operation Mode and the steady-state secondary control on the power plant level will be set to frequency and voltage control. The BESSs will need to be connected to the Main Grid.

In the Grid-Forming Inertia mode, the power plant and its components will be brought into the Grid-Forming Inertia Operation Mode and the steady-state secondary control on the power plant level will be set to active and reactive power control. The BESSs will need to be connected to the Main Grid.

In the Self-Supply mode, the part of power plant and its components connected to the auxiliary power supply circuit will be brought into the Grid-Forming Droop Operation Mode and will supply the auxiliary power to preserve the operation of the BESS power plant.

In the Black-Start with Self-Supply mode, the components connected to either auxiliary power supply circuit or the Main Grid will be brought into the Grid-Forming Droop Operation Mode and the auxiliary power supply circuit will provide the needed power for the power plant self-consumption while the main network will be used to black-start the connected electric grid by ramping up the electric grid's voltage.

In the Black-Start mode, the part of power plant and its components that are connected to the Main Grid will be brought into the Grid-Forming Droop Operation Mode and will attempt to ramp up the voltage of the network/sub-network to a configurable voltage level.

Operation of each BESS via the power plant controller in the various application modes may include all or a portion of the each BESS being connected to the electric grid to transfer electric power therebetween in the grid-following (GFL) mode, or one of the grid-forming (GFM) modes.

Operation of the BESS via the power plant controller in the various application modes may include all or a portion of the BESS being connected to an internal or auxiliary power grid to transfer electric power in the self-supply mode and/or the black-start mode.

Operation of the BESS via the power plant controller in the various application modes may include and all or a portion of the BESS being disconnected from the main grid and the auxiliary grid, and/or being in the standby mode.

A BESS, in terms of electrical components, is connected over a circuit breaker to a main electrical circuit/grid which is part of the electric grid. However, in Grid-Forming applications we can have more than one electrical circuit to which a BESS can be connected (like auxiliary, critical loads, etc.). Both the BESS control layers and the array control layer of the control system will need to monitor the state of a BESS's electrical connection, as it is essential for the operation of a Power Capacity Manager (PCM). This creates the need for a definition of a list of possible electrical networks that a BESS can implement, and which will define the way it is going to be operated.

The electrical networks include a main grid network, an auxiliary grid network, and a disconnected network, with each of the BESSs being assigned to one of the electrical networks. The power plant controller and substation controller assign permission states to the BESSs based upon whether the respective BESS is assigned to the main grid network, the auxiliary grid network, or the disconnected network. The assigned permission state determines the actual operation mode of the BESS and its nodes, with the circuit breakers being controlled based thereon.

Embodiments in accordance with the present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects that may generally be referred to herein as a “module” or “system.” Furthermore, the present disclosure may take the form of a computer program product embodied in a tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in a combination of one or more programming languages.

Elements of the plant controller described herein may be implemented in a cloud computing environment. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the claims.

What is claimed is:

1. An energy storage system having a self-supply mode, the system comprising:
a plurality of battery energy storage system (BESS) modules, first and second bus bars, a bus coupler, a plurality of BESS circuit breakers, a plant controller, and an auxiliary system;
wherein each of the BESS modules includes a plurality of rechargeable BESS enclosures, a power converter, and a plurality of internal circuit breakers;
wherein each of the BESS modules is connectable to an electric grid via a BESS transformer, a respective one of the plurality of BESS circuit breakers, and one of the first and second bus bars;
wherein the plant controller in communication with and operatively connected to the plurality of BESS modules, the bus coupler, and the plurality of BESS circuit breakers;
wherein the plant controller is configured to operate the energy storage system in a self-supply mode to supply electric power to the auxiliary system when the energy storage system is disconnected from the electric grid;
wherein the self-supply mode includes:
monitoring, for each of the plurality of rechargeable BESS enclosures, a state of charge parameter (SoC);
sequentially activating one of the plurality of rechargeable BESS enclosures to supply electric power to the auxiliary system; and
upon determining that SoC of the one of the plurality of rechargeable BESS enclosures is less than a threshold, deactivating the one of the plurality of rechargeable BESS enclosures and activating another of the plurality of rechargeable BESS enclosures to supply electric power to the auxiliary system.

2. The system of claim 1, further comprising wherein the plant controller is configured to detect an outage of the electric grid and disconnect the plurality of BESS modules from the electric grid in response thereto.

3. The system of claim 2, comprising the plant controller being configured to open the plurality of BESS circuit breakers to disconnect the plurality of BESS modules from the electric grid upon detecting the outage of the electric grid.

4. The system of claim 1, further comprising wherein the plant controller is configured to detect a weakening of the electric grid and disconnect the plurality of BESS modules from the electric grid in response thereto.

5. The system of claim 1, wherein the plurality of BESS modules further includes a thermal management system configured to manage thermal energy of the plurality of BESS modules, wherein the plant controller is operatively connected to the thermal management system, and wherein the plant controller is configured to minimize operation of the thermal management system to manage thermal energy of the plurality of BESS modules upon detecting an outage of the electric grid.

6. The system of claim 1, further comprising the plant controller being configured to disconnect the power converter of the respective one of the plurality of rechargeable BESS enclosures being deactivated.

7. The system of claim 1, wherein deactivating the one of the plurality of rechargeable BESS enclosures and activating another of the plurality of rechargeable BESS enclosures to supply electric power to the auxiliary system comprises deactivating the one of the plurality of rechargeable BESS enclosures subsequent to activating the another of the plurality of rechargeable BESS enclosures to supply electric power to the auxiliary system.

8. An energy storage system having a self-supply mode, the system comprising:
a plurality of BESS modules, first and second bus bars, a bus coupler, a plurality of BESS circuit breakers, a plant controller, and an auxiliary system;
wherein each of the BESS modules includes a plurality of rechargeable BESS enclosures, a power converter, and a plurality of internal circuit breakers;
wherein each of the plurality of BESS modules is connectable to an electric grid via a BESS transformer, a respective one of the plurality of BESS circuit breakers, and one of the first and second bus bars;
wherein the plant controller in communication with and operatively connected to the plurality of BESS modules, the bus coupler, and the plurality of BESS circuit breakers;
wherein the plant controller is configured to operate the energy storage system in a self-supply mode to supply electric power to the auxiliary system when the energy storage system is disconnected from the electric grid;
wherein the self-supply mode includes:
monitoring, for each of the plurality of rechargeable BESS enclosures, a state of charge parameter (SoC);
iteratively sequentially activating one of the plurality of rechargeable BESS enclosures to supply electric power to the auxiliary system;
upon determining that SoC of the one of the plurality of rechargeable BESS enclosures is less than a first SoC threshold, deactivating the one of the plurality of rechargeable BESS enclosures and activating another of the plurality of rechargeable BESS enclosures to supply electric power to the auxiliary system; and
upon determining that all the plurality of rechargeable BESS enclosures have been activated to supply electric power to the auxiliary system, incrementally reducing the first SoC threshold to a second SoC threshold and iteratively sequentially activating one of the plurality of rechargeable BESS enclosures to supply electric power to the auxiliary system.

9. The energy storage system of claim 8, further comprising wherein the plant controller is configured to detect an outage of the electric grid and disconnect the plurality of BESS modules from the electric grid in response thereto.

10. The energy storage system of claim 9, comprising the plant controller being configured to open the plurality of BESS circuit breakers to disconnect the plurality of BESS modules from the electric grid upon detecting the outage of the electric grid.

11. The energy storage system of claim 8, further comprising wherein the plant controller is configured to detect a weakening of the electric grid and disconnect the plurality of BESS modules from the electric grid in response thereto.

12. The energy storage system of claim 8, further comprising the plant controller being configured to disconnect the power converter of the respective one of the plurality of rechargeable BESS enclosures being deactivated.

13. The energy storage system of claim 8, wherein deactivating the one of the plurality of rechargeable BESS enclosures and activating another of the plurality of rechargeable BESS enclosures to supply electric power to the auxiliary system comprises deactivating the one of the plurality of rechargeable BESS enclosures subsequent to activating the another of the plurality of rechargeable BESS enclosures to supply electric power to the auxiliary system.

14. A method of self-supply for an energy storage system having a self-supply mode, the method comprising:
providing, an energy storage system that includes:
a plurality of battery energy storage system (BESS) modules;
wherein each of the BESS modules includes a plurality of rechargeable BESS enclosures, a power converter, and a plurality of internal circuit breakers; and
wherein each of the BESS modules is connectable to an electric grid via a BESS transformer, a respective one of the plurality of BESS circuit breakers, and one of the first and second bus bars; and
a first bus bar;
a second bus bar;
a bus coupler;
a plurality of BESS circuit breakers;
a plant controller; and
an auxiliary system;
wherein the plant controller in communication with and operatively connected to the plurality of BESS modules, the bus coupler, and the plurality of BESS circuit breakers; and
wherein the plant controller is configured to operate the energy storage system in a self-supply mode to supply electric power to the auxiliary system when the energy storage system is disconnected from the electric grid; and
wherein the self-supply mode includes:
monitoring, for each of the plurality of rechargeable BESS enclosures, a state of charge parameter (SoC);
sequentially activating one of the plurality of rechargeable BESS enclosures to supply electric power to the auxiliary system; and
upon determining that SoC of the one of the plurality of rechargeable BESS enclosures is less than a threshold, deactivating the one of the plurality of rechargeable BESS enclosures and activating another of the plurality of rechargeable BESS enclosures to supply electric power to the auxiliary system.

15. The method of claim 14, further comprising:
detecting, via the plant controller, an outage of the electric grid; and
disconnecting the plurality of BESS modules from the electric grid in response to the outage of the electric grid.

16. The method of claim 15, further comprising:
opening, via the plant controller, the plurality of BESS circuit breakers to thereby disconnect the plurality of BESS modules from the electric grid upon detecting the outage of the electric grid.

17. The method of claim 14, further comprising:
detecting, via the plant controller, a weakening of the electric grid; and
disconnecting the plurality of BESS modules from the electric grid in response the weakening of the electric grid.

18. The method of claim 14, further comprising:
managing, via a thermal management system, a thermal energy of the plurality of BESS modules; and
minimizing, via the plant controller that is operatively connected to the thermal management system, operation of the thermal management system to manage the thermal energy of the plurality of BESS modules upon detecting an outage of the electric grid.

19. The method of claim 14, further comprising:
disconnecting, via the plant controller, the power converter of the respective one of the plurality of rechargeable BESS enclosures being deactivated.

20. The method of claim 14, wherein deactivating, via the plant controller, the one of the plurality of rechargeable BESS enclosures, and activating another of the plurality of rechargeable BESS enclosures to supply electric power to the auxiliary system further comprises:
deactivating, via the plant controller, the one of the plurality of rechargeable BESS enclosures subsequent to activating the another of the plurality of rechargeable BESS enclosures to supply electric power to the auxiliary system.
